(19) United States
(12) Patent Application Publication
(10) Pub. No.: US 2009/0039547 A1
(43) Pub. Date: Feb. 12, 2009

(54) METHOD FOR PRODUCING AN OBJECT INCLUDING AT LEAST ONE AUTONOMOUS MOVING PART AND ONE FIXING PART

(75) Inventors: Guido Finnah, Karlsruhe (DE); Juergen Hausselt, Germersheim (DE); Klaus Plewa, Germersheim (DE); Volker Piotter, Linkenheim-Hochstetten (DE); Steffen Rath, LInkenheim-Hochstetten (DE); Robret Ruprecht, Walzbachtal (DE)

Correspondence Address: DARBY & DARBY P.C., P.O. BOX 770, Church Street Station, New York, NY, 10008-0770, US

(73) Assignee: Forschungszentrum Karlsruhe GmbH, Karlsruhe (DE)

(21) Appl. No.: 12/066,977

(22) PCT Filed: Aug. 25, 2006
(86) PCT No.: PCT/EP2006/008330

§ 371 Date: Mar. 14, 2008

(30) Foreign Application Priority Data
Sep. 14, 2005 (DE) 10 2005 043 772.9

(51) Int. Cl. B29C 45/14

(52) U.S. Cl. 264/242

(57) ABSTRACT

A method for producing an object including at least one autonomous part movably disposed relative to an affixing part includes: providing a mold having at least one cavity configured to produce the at least one autonomous part; filling the at least one cavity with a curable or solidifying molding compound that includes a pulverulent sintering material and a binder; allowing the molding compound to solidify so as to form the at least one autonomous part; removing the at least one autonomous part from the cavity; disposing the at least one autonomous part in or on the affixing part so as to form a preform; and heat treating the preform so as to form the object.

The present invention relates to a method for the production of an object consisting of at least one autonomous part and one affixing part, whereby the autonomous part is positioned so as to be moveable relative to the affixing part. If there are at least two autonomous parts, they are positioned in the affixing part with respect to each other in such a way that they are connected so that they can move relative to each other.

German patent application DE 33 40 122 A1 discloses a method for using injection molding to produce an object consisting of at least two autonomous parts that are connected so that they can move relative to each other and that are positioned firmly with respect to each other in at least one affixing part, a process in which different plastics are employed to produce the moveable parts that are connected to each other. Towards this end, firstly an injection molded part is manufactured in a cavity. This part is then removed from the cavity and placed into a larger cavity in the same mold, or else the cavity is enlarged by means of movements of the mold. The selection of incompatible plastics means that the materials of the two components do not join together and the parts remain moveable relative to each other. As an alternative, the mobility can be achieved by using identical plastics in that the second component is processed at the lower limit of the processing temperature. For this purpose, it is advantageous if both components are used at low processing temperatures or if the component for the part that is injection-molded first is briefly exposed to high working temperatures. The loose connection is established when the thermal shrinkage that is common for plastics occurs. This method is not suitable for the production of a loose connection of ceramic molding compounds or metals since the incompatibility of the plastics is a prerequisite for this method which, in addition, does not involve a heat treatment.

German patent specification DE 196 52 223 C2 discloses structured molded parts made of at least two different materials, which are joined together in a composite. This specification also describes the establishment of a low-tension joint zone resulting from a suitable material composition or different particle content in partial volumes of the materials. For example, a pure binder is used in order to create hollow objects. The production of moveable components is not disclosed.

The article titled “Spritzgieβen ersetzt die Montage” [Injection molding replaces assembly] in VDI-Nachrichten [News of the German Association of Engineers] dated Oct. 22, 2004, page 30, describes a method for the production of a microgear (planetary gearing). By means of two-component injection molding, the sun and planet gears are injection-molded out of non-adhesion-compatible plastics and subsequently encapsulated with the cover plates and the axles. Owing to the geometry of the molded part, to the incompatibility and to the shrinkage behavior of the plastics of which the cover plates and the axles are made, the gear wheels remain moveable on the axles. Moreover, three injection operations are necessary to produce one gear consisting of two gear wheels and an affixing part.

Before this background, the present invention is based on the objective of proposing a method for the production of an object consisting of at least one autonomous part and one affixing part, whereby the at least one part is positioned so as to be moveable relative to an affixing part, said method being free of the above-mentioned drawbacks and limitations. In particular, this method should allow the production of an object consisting of metallic, vitreous or ceramic components by means of injection molding or hot casting in a single work step in order to reduce or avoid the need for manipulations or adjustments after the parts of the object have been molded.

This objective is achieved by the method steps of claim 1 or 2. The subordinate claims describe advantageous embodiments of the invention.

The method according to the invention for the production of an object encompasses steps a) through e).

First of all, according to step a), a mold is provided that has a cavity to receive one of the parts to be molded.

In order to produce an object consisting of at least two autonomous parts, the mold also has at least a mold parting surface that divides the mold into two halves. The decisive aspect here is the arrangement of the cavities relative to this mold parting surface: the cavities are arranged side-by-side with respect to the mold parting surface alternately above or below the mold parting surface in such a way that they alternately lie in one of the two mold halves, whereby the cavities remain separated from each other.

Subsequently, according to step b), the at least one cavity is filled with a curable or solidifying molding compound that contains a sintering material. The parts to be molded are formed in the cavities once the molding compound has been left to solidify.

For this purpose, in a preferred embodiment of the method according to the invention, the material for the injection molding or hot casting is fed into the cavities from at least one injection unit via at least one runner, either simultaneously or consecutively. Two-component or multiple-component injection molding is particularly well-suited for this purpose.

Subsequently, according to step c), each formed part is removed from its cavity.

In a special embodiment, the mold already has an affixing part to receive the parts to be molded. As a result, the object is already molded during step b) or c), and the subsequent step d) is dispensed with.

If the mold itself does not already have an affixing part to receive the parts to be molded then, after the parts have been removed from the mold, according to step d), they are placed into an affixing part or, preferably, into a cavity that, when filled, forms the molded part.

In an embodiment according to the invention, the demolded parts are mounted onto or joined to the affixing part.

In a preferred embodiment, all of the demolded parts are transferred into at least one other cavity likewise present in the mold and the affixing part is formed when this cavity is filled. The transfer of the parts from the cavities in which they were molded into the other cavity is preferably done by means of guide elements which, after the transfer, can remain completely or partially in the at least one additional cavity. In those places where the guide elements are demolded, the additional cavity is further enlarged so that, when the latter is filled, an additional connection is established between at least one part and the affixing part. At the same time, the guide elements or parts thereof can serve as ejectors for purposes of achieving a simpler handling technique.

Finally, in step e), the yet unfinished object, which can be referred to as a preform, is subjected to a heat treatment, especially a binder-removal procedure, followed by sintering. To this end, various molding compounds, which are called feedstocks and consist of a binder and a powder of the desired material, are injected into the mold in such a way that they can touch each other. The parts can also be injection-molded from the same feedstock. In order to convert the molding compounds into a part made of metal, glass or ceramic, the binder on the basis of water, oligomers, polymers or mixed systems has to be removed after the molding procedure and the powder has to be sintered to form a generally dense material, a process in which shrinkage takes place. This shrinkage leads to a reduction in the size of the object in comparison to the at least one injection-molded part, which is likewise called a preform.

In order to be able to sinter the object, which can consist of various components, the materials have to have similar sintering temperatures or else the design of the gear has to allow a component that sinters sooner to also shrink sooner than the component that only sinters at a higher temperature. The distance and play between the parts with respect to each other as well as between the parts and the affixing part can be established on the basis of the differences in the sintering shrinkage of the materials employed for the parts and for the affixing parts. In many cases, it is advantageous in this context for the affixing parts to shrink to a greater extent than the moveable parts. The sintering shrinkage of sintering materials generally ranges from 10% to 25%, while the thermal shrinkage of plastics amounts to 3% at the maximum.

According to the invention, the parts are made of metal, an alloy, a (mixed) ceramic or glass. Preference is given to the use of hard metal, temperable metal or steel, as well as hard or tough ceramic, consisting of silicon nitride or silicon carbide. Especially preferred for the moveable parts in gears (gear wheels) or in joints is tempered steel (preferably 17-4PH) or a tough ceramic, particularly zirconium dioxide.

The materials used for the affixing part are preferably hard metals (for instance, tungsten carbide cobalt), tempered metals, hard ceramics (especially aluminum oxide), silicon nitride or silicon carbide. The affixing part, however, does not necessarily have to be made of a sintering material. In this case, however, it is advantageous for the affixing part to be placed directly into the mold.

A major advantage of the present invention is that the parts and the affixing parts can be made of wear-resistant and/or high-strength materials. Furthermore, the parts do not have to be assembled after the molding and the sintering. Particularly in the case of microdimensions, the aspect of handling and adjusting the parts is very cost-intensive due to the requisite level of precision. The assembly of the preforms is made more difficult in that the feedstock is not a very strong material because of the binder and the high degree of filling with powder.

The method according to the invention is suitable for use in microsystem technology, in powder injection molding, in two-component powder injection molding, in gearing technology (planetary gearing, ball-and-socket joints, bearings, linear guides, etc.) as well as in production engineering for gear manufacturing. The method according to the invention makes it possible to pair the moveable parts of the gear with each other already during the molding process and to install them in a housing that supports the moveable parts.

The present invention will be described in greater detail below with reference to embodiments and the drawings. These show the following:

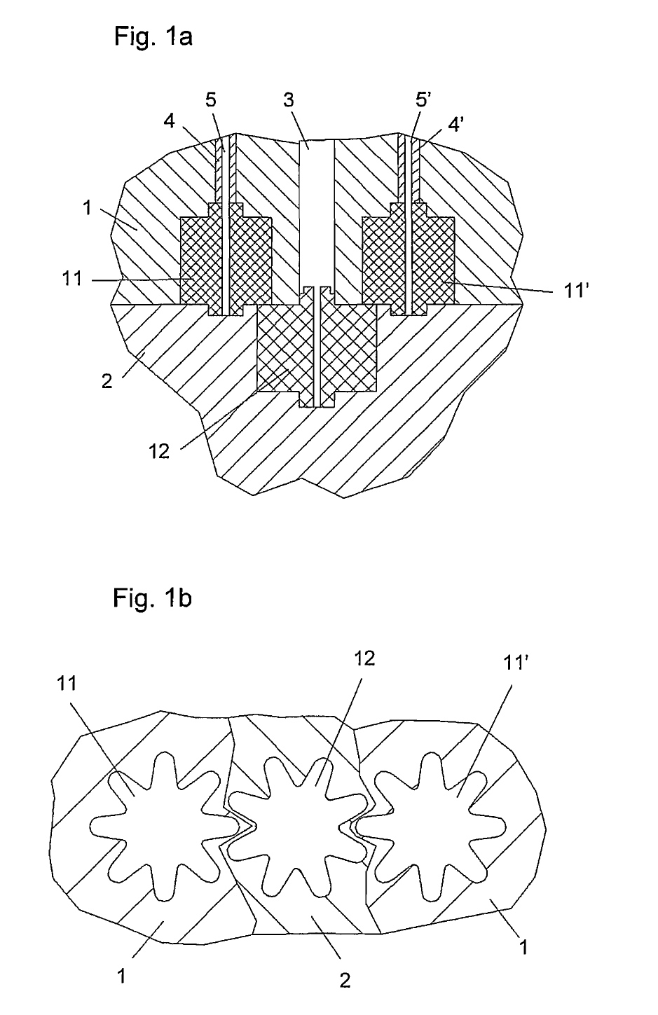

FIG. 1—a schematic representation of a mold for the production of a preform of a gear wheel (planetary gearing):

FIG. 1a: cross section

FIG. 1b: top view of the cavities in various planes;

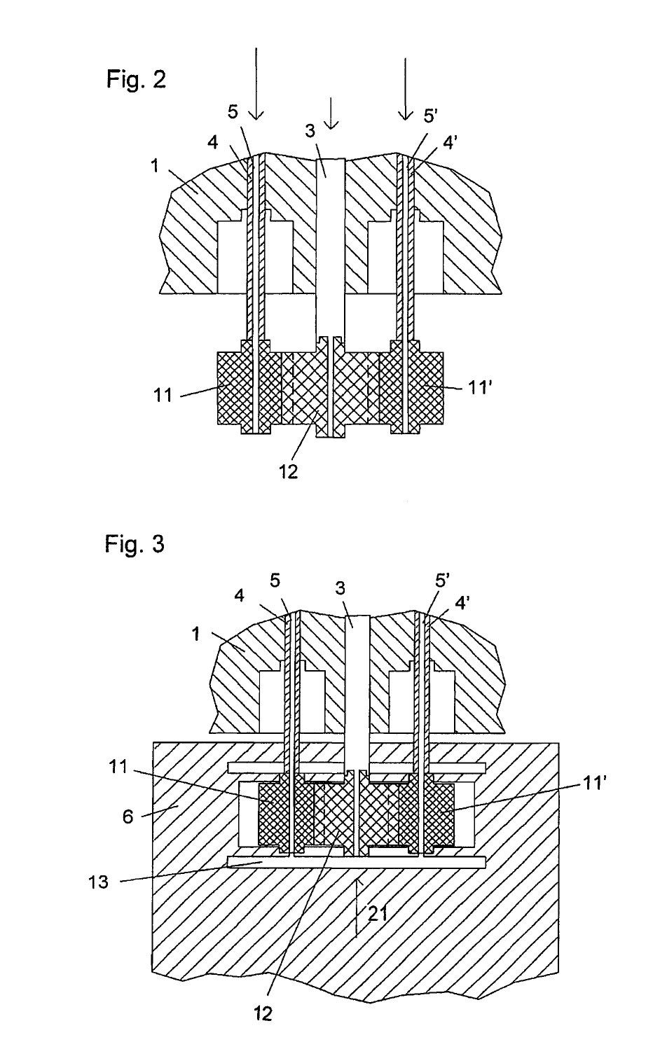

FIG. 2—demolding and positioning of the gear wheels with respect to each other;

FIG. 3—fixation of the gear wheels in another cavity;

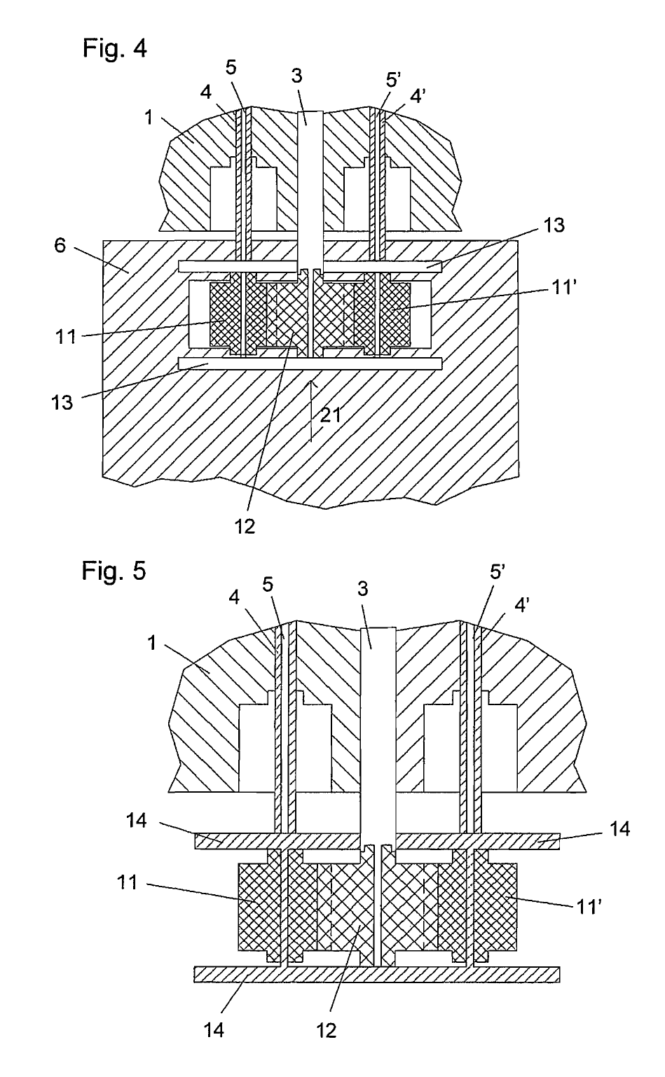

FIG. 4—removal of the ejector from the two outer gear wheels;

FIG. 5—molding of the affixing part by filling the additional cavity;

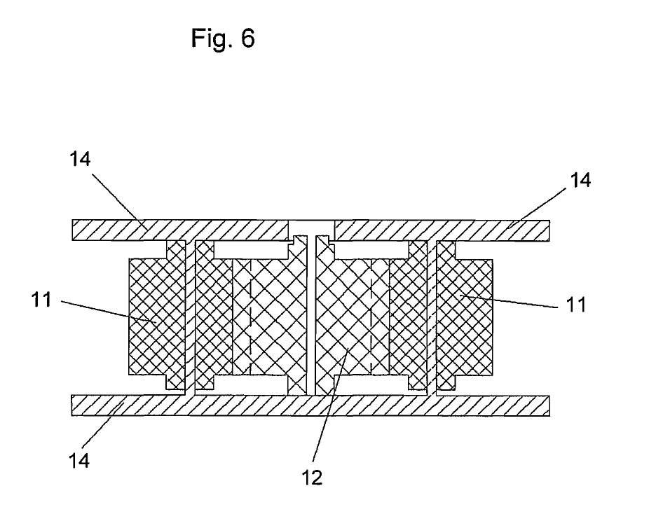

FIG. 6—preform of the object.

Up until now, experiments have been carried out to produce feedstocks and to powder-injection mold these feedstocks to create single-component parts made of ZrO₂, Al₂O₃, mixed ceramic ZTA, steel grades 17-4PH and 316L, and their measure of shrinkage was set by means of the size, shape and content of the particles of the powder. The same as well as different binders on the basis of water, oligomers, polymers or mixed systems were used.

The first embodiment describes the production of a gear drive according to FIG. 6 by means of two-component injection molding.

The mold schematically shown in FIG. 1a is employed for this purpose; it has three cavities for three gear wheels 11, 11′, 12 that are to be made and that, as can be seen in FIG. 1b, are arranged next to each other in an axially offset manner. The mold also has a mold parting surface that divides the mold into two halves 1, 2, namely, into the mold half 1 on the ejector side and into the mold half 2 on the nozzle side. In this context, the two outer cavities for the gear wheels 11, 11′ are arranged on a first plane in the mold half 1 on the ejector side, and the middle cavity for the gear wheel 12 is arranged on a second plane, which is located above the first plane in the mold half 2 on the nozzle side.

When the first feedstock with zirconium oxide powder is injected, all three cavities for the gear wheels 11, 11′, 12 are almost simultaneously filled with feedstock. After the feedstock has solidified, the mold is opened along the mold parting surface between the mold half 1 on the ejector side and the mold half 2 on the nozzle side, and the three gear wheels 11, 11′, 12 are removed from the cavities in such a way that the tooth geometry is exposed while all three gear wheels 11, 11′, 12 are at first still situated on the ejectors 3, 5, 5′. The ejectors 5, 5′ each touch the gear wheels 11, 11′, 12 only on their inner diameter. The ejectors can be stepped, that is to say, provided with an ejector sleeve 4, 4′ so that a force exerted by the front of the ejector sleeve onto the gear wheel assists the demolding of the ejector.

As shown schematically in FIG. 2, during the demolding, the ejectors 3, 5, 5′ push all three gear wheels 11, 11′, 12 beyond the mold parting surface between the mold half 1 on the ejector side and the mold half 2 on the nozzle side, so that all three gear wheels 11, 11′, 12 lie in a third plane, as a result of which they mesh.

Subsequently, according to the schematic depiction in FIG. 3, the gear wheels 11, 11′, 12 are gripped by mold jaws 6 that have a cavity for the fixation of the gear wheels, and the ejectors 5, 5′ are pulled out of the outer gear wheels 11, 11′, while the inner ejector 3, as schematically shown in FIG. 4, remains in the central gear wheel 12. In the area of the hubs of the outer gear wheels 11, 11′, the mold jaws 6 have a cavity 13 for the affixing part. In an advantageous embodiment of the middle ejector 3, it does not have a round, but rather an oval or angular shape in the area where it is attached in the hub of the gear wheel 12, so that, after the heat treatment, a drive axle can be slid with a positive fit into the middle gear wheel 12.

The mold jaws 6 that surround all three gear wheels 11, 11′, 12 are encapsulated by injection molding with a second feedstock containing aluminum oxide powder above and below the third plane in which the gear wheels 11, 11′, 12 now lie, each on the side facing away from the gear wheels 11, 11′, 12. The gate can be positioned as desired, although it is advantageous to have a gate in position 21. In this process, the second feedstock fills the cavities in the mold jaws 6 as well as the volume of the cavities in the outer gear wheels 11, 11′ freed up by the retracted ejectors 5, 5′, thus forming the axles of these gear wheels 11, 11′, 12. In the area of the hubs of the gear wheels made of the first feedstock, the second feedstock touches the first feedstock, without this resulting in a mixing of the two feedstocks.

An advantageous embodiment of the mold jaws 6 consists of configuring the mold jaws 6 with a double wall. Here, the space between the two walls and the axles of the two outer gear wheels 11, 11′ is filled with the second feedstock. In this case, no additional mold is needed to limit the outer shape of the second feedstock. The second feedstock thus also forms an affixing part 14 for the gear. The affixing part 14 can later serve as the housing for the gear.

Once the second feedstock has solidified, according to the schematic depiction in FIG. 5, the mold jaws 6 are pulled out of the preform that now consists of two feedstocks. The binder removal behavior is coordinated by using the same or a similar binder in the feedstock. Owing to the fact that the distribution, degree of filling and shape of the powder particles have all been coordinated, both feedstocks sinter at the same sintering temperature with a sintering shrinkage that is either the same for the parts 11, 11′, 12 and for the affixing part 14 or else that has somewhat higher values for the affixing part 14.

If the zirconium dioxide parts adhere to the aluminum oxide parts, these turn into a detachable connection at the time of the first movement of the gear.

The second embodiment is a variant of the first embodiment, whereby the gear wheel according to FIG. 6 is produced by means of three-component injection molding.

Here, the gear wheels 11, 11′, 12 are molded analogously to the first example. The affixing part 14 that concurrently serves as the housing is also molded in the same manner. However, during the injection of the second feedstock for the housing, all of the ejectors 3, 5, 5′ remain in the hubs of the gear wheels 11, 11′, 12. Only subsequently are the ejectors 5, 5′ for the outer gear wheels 11, 11′ retracted and the freed-up hollow space is filled with a third feedstock that fills the volume of the axles of the two outer gear wheels 11, 11′. Like the second feedstock, the third feedstock also contains aluminum oxide powder, albeit with a powder degree of filling and/or a size distribution of the powder particles that allows greater shrinkage during sintering than in the first or second feedstock. In this manner, a smaller bearing clearance is created between the gear wheels 11, 11′ and the axles. The length of the axles is dimensioned by the shape of the mold in such a way that it matches the sintering shrinkage. The second feedstock can have the same or slightly less sintering shrinkage in comparison to the first feedstock. The distance and play between the gear wheels and the affixing part are set by means of the difference in sintering shrinkage.

Special embodiments of the molds and gears will be described below.

It is advantageous to configure the mold as a three-plate mold with a turntable in the mold half 1 on the ejector side. After the gear wheels 11, 11′, 12 have been molded and the mold has been opened, the sprue system and the runner system or the hot runner are separated from the gear wheels 11, 11′, 12. Subsequently, using the turntable, the mold half 1 on the ejector side turns the gear wheels 11, 11′, 12 towards the mold jaws 6 that can be attached to the nozzle side, to the mold half 1 on the ejector side, to the mold half 2 on the nozzle side or else outside of the mold. A special embodiment of the mold allows the next gear wheels to be formed already during the molding of the affixing part 14 (housing) or of the axles in the cavities of the tooth geometry that are advantageously arranged in the mold half 2 on the nozzle side.

If a larger clearance is to be set between the front surfaces of the gear wheels and the hub areas of the housing, then at least two possibilities are available. On the one hand, the clearance is defined by the thickness of the mold jaws 6 and by the sintering shrinkage as well as by the difference in the sintering shrinkage between the first and the second feedstocks.

On the other hand, small pyramidal or conical microelevations can be shaped onto the gear wheels or onto the housing in the area of the hubs or of the front surfaces of the gear wheels. Even if the gear wheels and the housing should sinter together in the area of the tips of the pyramid or cones—something that occurs, for instance, when different steel grades are used—the application of a torque between the gear wheels and the housing in the preform state or preferably in the sintered state can easily break this joint since it is very small.

### LIST OF REFERENCE NUMERALS

1 mold half 1 on the ejector side
2 mold half 2 on the nozzle side
3 ejector for the central part
4, 4′ ejector sleeve for the outer parts
5, 5′ ejector for the outer parts
6 mold jaws with cavity for the affixing part
11, 11′ outer part (gear wheels)
12 central part (gear wheels)
13 cavity for the affixing part
14 affixing part
21 gate

1-11. (canceled)

12. A method for producing an object including at least one autonomous part movably disposed relative to an affixing part, the method comprising:
providing a mold having at least one cavity configured to produce the at least one autonomous part;
filling the at least one cavity with a curable or solidifying molding compound that includes a pulverulent sintering material and a binder;
allowing the molding compound to solidify so as to form the at least one autonomous part;
removing the at least one autonomous part from the cavity;
disposing the at least one autonomous part in or on the affixing part so as to form a preform; and
heat treating the preform so as to form the object.

13. The method according to claim 12, wherein the object is made of at least two autonomous parts that are connected so as to be movable relative to each other, and further comprising positioning the at least two autonomous parts in the affixing part, wherein the mold includes at least two cavities and a mold parting surface that divides the mold into two halves, each half including one of the at least two cavities, each of the cavities separated from each other.

14. The method according to claim 13, further comprising, after each of the cavities have been filled, arranging the at least two autonomous parts in a plane such that the two autonomous parts mesh without touching each other.

15. The method according to claim 12, wherein the filling the at least one cavity includes feeding the molded compound for an injection molding or hot casting into the at least one cavity from at least one injection unit via at least one runner.

16. The method according to claim 12, further comprising forming the affixing part by transferring the at least one autonomous part into at least one additional cavity in the mold such that the affixing part is formed after the at least one additional cavity is filled with a material different than the molding compound.

17. The method according to claim 12, wherein the filling the at least one cavity is performed using at least two materials in a two-component or multiple-component injection molding process.

18. The method according to claim 12, wherein the disposing the at least one autonomous part in the affixing part includes providing a firm connection between the at least one autonomous part and the affixing part, and wherein the heat treating of the object moves the connection to such a distance between the at least one autonomous part and the affixing part such that the at least one autonomous part becomes moveable relative to the affixing part.

19. The method according to claim 18, wherein the removing the autonomous part includes transferring the at least one autonomous part using guide elements.

20. The method according to claim 19, wherein the guide elements remain completely or partially in the at least one cavity after the transferring.

21. The method according to claim 12, wherein the heat treating includes sintering and further comprising using a binder-removal procedure on the object.

22. A method for producing an object including at least one autonomous part movably disposed so as to be moveable relative to an affixing part, the method comprising:
providing a mold including an affixing part and at least one cavity configured to produce the at least one autonomous part;
filling the at least one cavity with a curable or solidifying molding compound that includes a pulverulent sintering material and a binder;
allowing the molding compound to solidify so as to form the at least one autonomous part;
removing the at least one autonomous part from the cavity; and
heat treating the at least one autonomous part and the affixing part so as to form the object.

23. The method according to claim 22, wherein the object is made of at least two autonomous parts that are connected so as to be movable relative to each other, and further comprising positioning the at least two autonomous parts in the affixing part, wherein the mold includes at least two cavities and a mold parting surface that divides the mold into two halves, each half including one of the at least two cavities, each of the cavities separated from each other.

24. The method according to claim 23, further comprising, after each of the cavities have been filled, arranging the at least two autonomous parts in a plane such that the two autonomous parts mesh without touching each other.

25. The method according to claim 23, wherein the filling the at least one cavity includes feeding the molded compound for an injection molding or hot casting into the at least one cavity from at least one injection unit via at least one runner.

26. The method according to claim 23, further comprising forming the affixing part by transferring the at least one autonomous part into at least one additional cavity in the mold such that the affixing part is formed after the at least one additional cavity is filled with a material different than the molding compound.

27. The method according to claim 22, wherein the filling the at least one cavity is performed using at least two materials in a two-component or multiple-component injection molding process.

28. The method according to claim 22, wherein the disposing the at least one autonomous part in the affixing part includes providing a firm connection between the at least one autonomous part and the affixing part, and wherein the heat treating of the object moves the connection to such a distance between the at least one autonomous part and the affixing part such that the at least one autonomous part becomes moveable relative to the affixing part.

29. The method according to claim 28, wherein the removing the autonomous part includes transferring the at least one autonomous part using guide elements.

30. The method according to claim 29, wherein the guide elements remain completely or partially in the at least one cavity after the transferring.

31. The method according to claim 22, wherein the heat treating includes sintering and further comprising using a binder-removal procedure on the object.
